(19) United States
(12) Patent Application Publication
(10) Pub. No.: US 2002/0140877 A1
(43) Pub. Date: Oct. 3, 2002

(54) Thin film transistor for liquid crystal display and method of forming the same

(75) Inventor: Hsin-Ming Chen, Tainan Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU OPTRONICS CORP.

(21) Appl. No.: 10/109,931

(22) Filed: Mar. 29, 2002

(30) Foreign Application Priority Data
Mar. 30, 2001 (TW) 90107640

(51) Int. Cl. G02F 1/1343

(52) U.S. Cl. 349/38

(57) ABSTRACT

A TFT-LCD has a plurality of arrayed pixel regions formed by a plurality of gate lines extending in a first direction and a plurality of data lines extending in a second direction, wherein each data line is perpendicular to each gate line. Each of the pixel regions has a pixel electrode covering the rectangular area, a TFT on a first region of the gate line, a capacitor on a second region of the gate line, and a metal shielding layer over the intersection of the gate line and the data line.

### BACKGROUND OF THE INVENTION

1. Field of the Invention

The present invention relates to a liquid crystal display (LCD)) using thin film transistors (TFTs) as its active devices and method of forming the same, and more particularly, to a TFT formed using an attenuated mask.

2. Description of the Related Art

Liquid crystal displays (LCDs) are a well known form of flat panel displays. As is well known to those in the art, when a voltage is applied to the LCD, liquid crystal molecules are rearranged to result in various photo-electronic effects. The LCD using thin film transistors (TFTs) as its active devices, TFT-LCD, has advantages of low power consumption, lightweight, thin profile and low driving voltage.

FIG. 1A is a top view showing a conventional TFT-LCD. The conventional TFT-LCD has a plurality of display regions 2 formed in array by transverse-extending gate lines 12 and lengthwise-extending data lines 20, in which each display region 2 has a pixel electrode 28, a TFT structure 4 and a capacitor 6. The TFT structure 4 has a source electrode 24A electrically connected to an extending portion of the data line 20, and a drain electrode 24B electrically connected to the pixel electrode 28.

FIG. 1B is a sectional diagram along lines I-I′, II-II′ and III-III′ shown in FIG. 11A. In the conventional TFT process, a first metal layer is deposited on a glass substrate 10, and then patterned by using a first mask so as to form the gate line 12, in which a first predetermined region of the gate line is used as a gate electrode 12A and a second predetermined region of the gate line 12 is used as a storage capacitor 12B. Next, an insulating layer 14, an amorphous silicon (a-Si) layer 16, an n⁺-doped a-Si layer 18 and a second metal layer are successively deposited on the entire surface of the glass substrate 10. Thereafter, using a second mask, the second metal layer is patterned to serve as the data line 20, an upper capacitor plate 22 and a source/drain metal layer 24, wherein an island structure consisting of the source/drain metal layer 24, the n⁺-doped a-Si layer 18 and the a-Si layer 16 is formed over the gate electrode 12A.

Then, using a third mask, a first opening 25 is formed on the island structure, thus the source/drain metal layer 24 is patterned to be the source electrode 24A and the drain electrode 24B. After removing the n⁺-doped a-Si layer 18 within the first opening 25, the remaining part of the n⁺-doped a-Si layer 18 serves as a source region 18A and a drain region 18B, and the exposed region of the a-Si layer 16 serves as a channel. Next, a protection layer 26 is deposited and patterned by a fourth mask, thus a second opening 27 is formed to expose the drain electrode 24B and a third opening 29 is formed to expose the upper capacitor plate 22. Finally, an indium tin oxide (ITO) layer is deposited to fill the second opening 27 and the third opening 29, and then patterned by a fifth mask so as to serve as the pixel electrode 28.

### SUMMARY OF THE INVENTION

The present invention provides a TFT-LCD and a method of forming the same to increase the aperture ratio, increase yield and decrease process costs.

The TFT-LCD has a plurality of arrayed pixel regions and formed by a plurality of gate lines extending in a first direction and a plurality of data lines extending in a second direction, wherein each data line is perpendicular to each gate line. Each of the pixel regions has a pixel electrode covering the rectangular area, a TFT on a first region of the gate line, a capacitor on a second region of the gate line, and a metal shielding layer over the intersection of the gate line and the data line.

A method of forming the TFT-LCD comprises steps of: providing a substrate; depositing and patterning a first metal layer on the substrate to form a gate line and a predetermined data line, wherein a first region of the gate line serves as a gate electrode and a second region of the gate line serves as a storage capacitor; successively forming an insulating layer, a first semiconductor layer, a second semiconductor layer and a second metal layer on the entire surface of the substrate; using the predetermined data line as mask to pattern the second metal layer as a data line, and forming an island structure having the second metal layer, the second semiconductor layer and the first semiconductor layer over the gate electrode; forming a first opening on the island structure to separate the second metal layer as a source electrode and a drain electrode and separate the second metal layer as a source region and a drain region, and removing the second metal layer and the second semiconductor layer over the storage capacitor; forming a protection layer having a second opening on the intersection of the data line and the gate line, a third opening on the source electrode, a fourth opening on the drain electrode, and a fifth opening over the capacitor storage, wherein the fifth opening passes through the protection layer and the first semiconductor layer over the capacitor storage; and forming a transparent conductive layer to fill the second opening, the third opening, the fourth opening and the fifth opening, and patterning the transparent conductive layer as a metal shielding layer, a pixel electrode, and an upper capacitor plate. The metal shielding layer fills the second opening and covers the intersection of the gate line and the data line and extends to fill the third opening, the pixel electrode fills the fourth opening and covers a rectangular region formed by the gate line and the data line, and the upper capacitor plate fills the fifth opening and covers the storage capacitor.

Accordingly, it is a principal object of the invention to use three masks and two attenuated masks to pattern the TFT-LCD.

It is another object of the invention to use the final mask to pattern the pixel electrode, the upper capacitor plate and the metal shielding layer at the same step.

Yet another object of the invention is to increase yield and decrease process costs of the TFT-LCD process

It is a further object of the invention to form the upper capacitor plate of transparent conductive materials to increase the aperture ratio of the TFT-LCD.

Still another object of the invention is to provide the metal shielding layer to modulate the controlling voltage and solve the problem caused by the peripheral high-resistance circuits.

These and other objects of the present invention will become readily apparent upon further review of the following specification and drawings.

### BRIEF DESCRIPTION OF THE DRAWINGS

FIG. 1A is a top view showing a conventional TFT-LCD.

FIG. 1B is a sectional diagram along lines I-I′, II-II′ and III-III′ shown in FIG. 1A.

FIG. 2 is a top view showing a TFT-LCD according to the first embodiment of the present invention.

FIGS. 3A to 3D are top views showing the method of forming the TFT-LCD shown in FIG. 2.

FIGS. 4A to 4E are sectional views along lines I-I′, II-II′, III-III′ shown in FIG. 3.

FIG. 5A is a top view showing a TFT-LCD according to the second embodiment of the present invention.

FIG. 5B is a sectional view along lines I-I′, II-II′, III-III, shown in FIG. 5A.

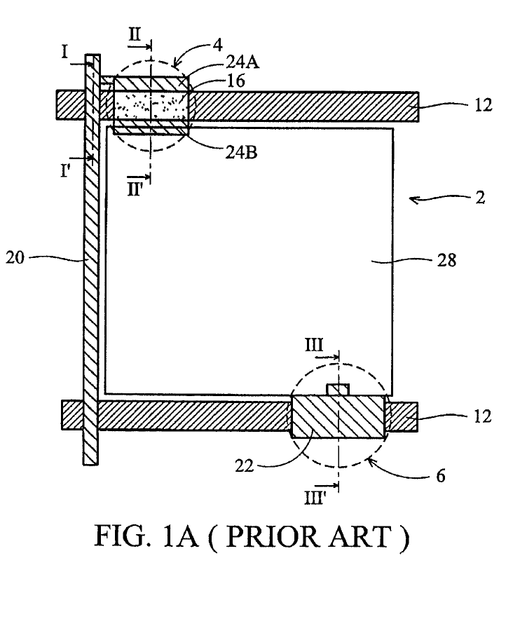

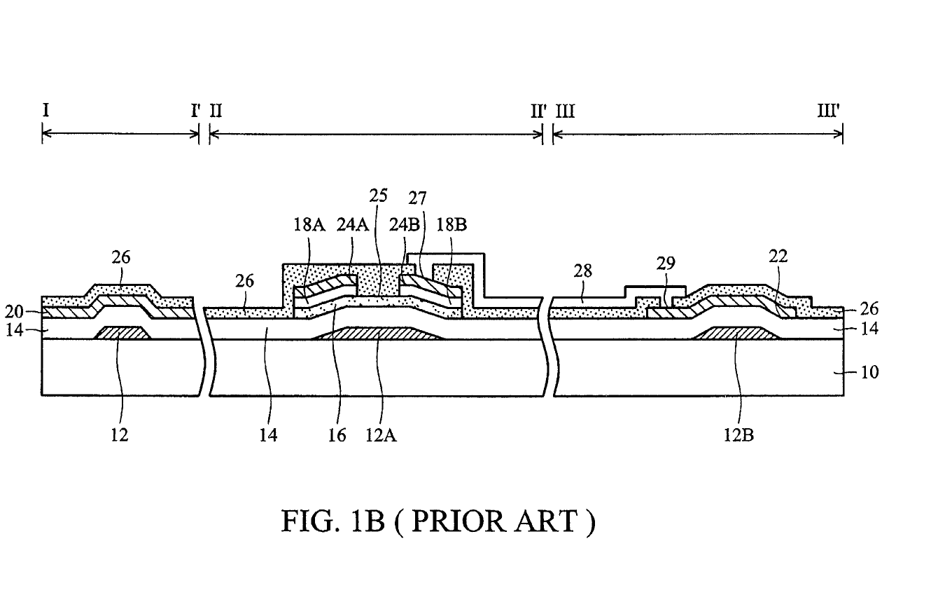

Similar reference characters denote corresponding features consistently throughout the attached drawings.

### DETAILED DESCRIPTION OF THE PREFERRED EMBODIMENTS

### First Embodiment

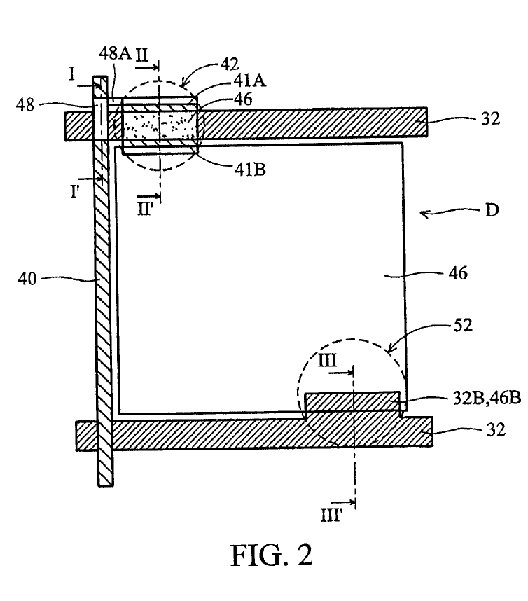

FIG. 2 is a top view showing a TFT-LCD according to the first embodiment of the present invention. The TFT-LCD has a plurality of display regions D formed in array by transverse-extending gate lines 32 and lengthwise-extending data lines 40, in which each display region D has a pixel electrode 46, a TFT structure 42, a capacitor 52 and a metal shielding layer 48. The metal shielding layer 48 is formed over the intersection of the data line 40 and the gate line 32 to modulate the controlling voltage and solve the problem caused by the peripheral high-resistance circuits. The TFT structure 42 has a gate electrode formed on a first region of the gate line 32, a source electrode 41A electrically connected to an extending portion 48A of the data line 40 through the metal shielding layer 48, and a drain electrode 41B electrically connected to the pixel electrode 46. The capacitor 52 has a storage capacitor 32B formed on a second region of the gate line 32, and an upper capacitor plate 46B formed on a part of the pixel electrode 46 that covers the storage capacitor 32B. In addition, the pixel electrode 46, the upper capacitor plate 46B and the metal shielding layer 48 can be formed at the same time by depositing and patterning an ITO layer, thus the TFT-LCD has a higher aperture ratio.

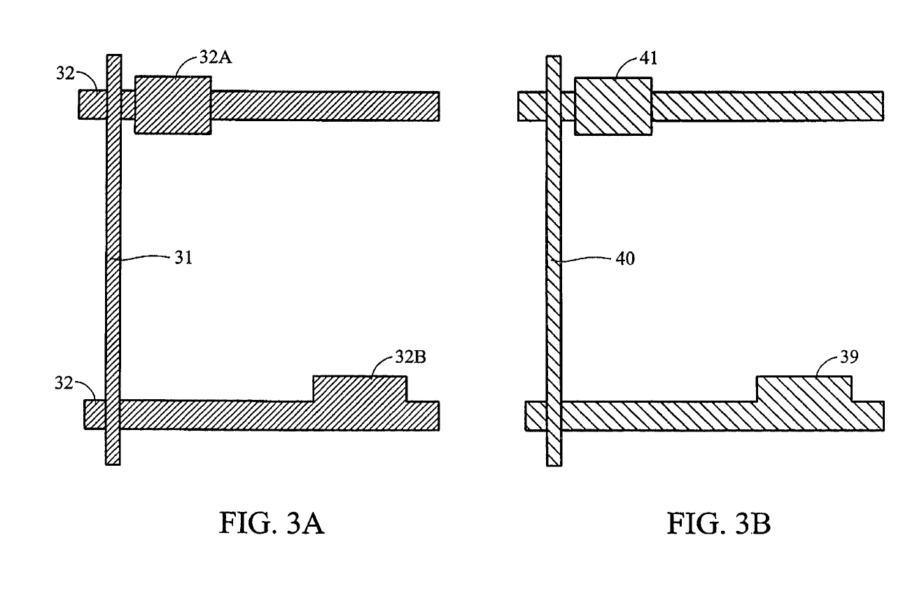

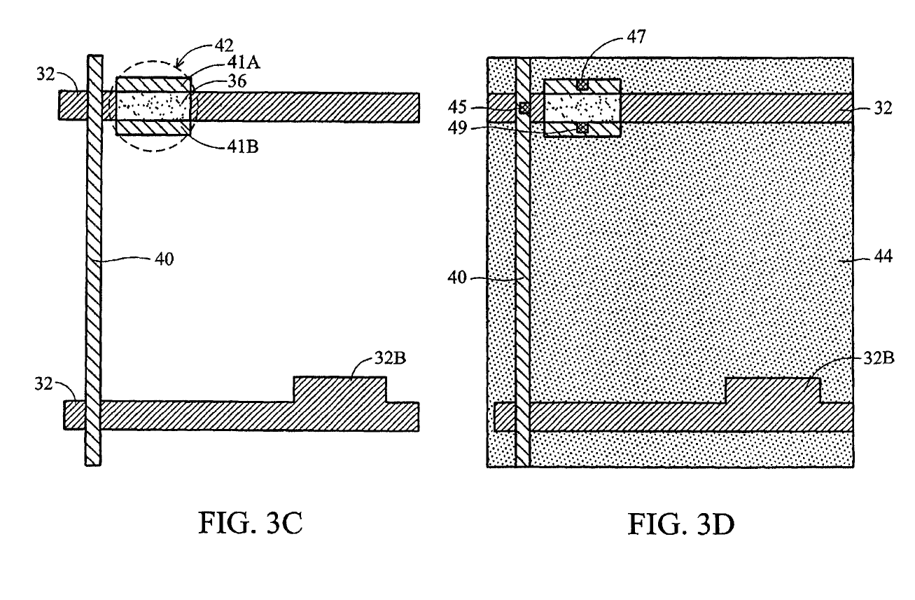

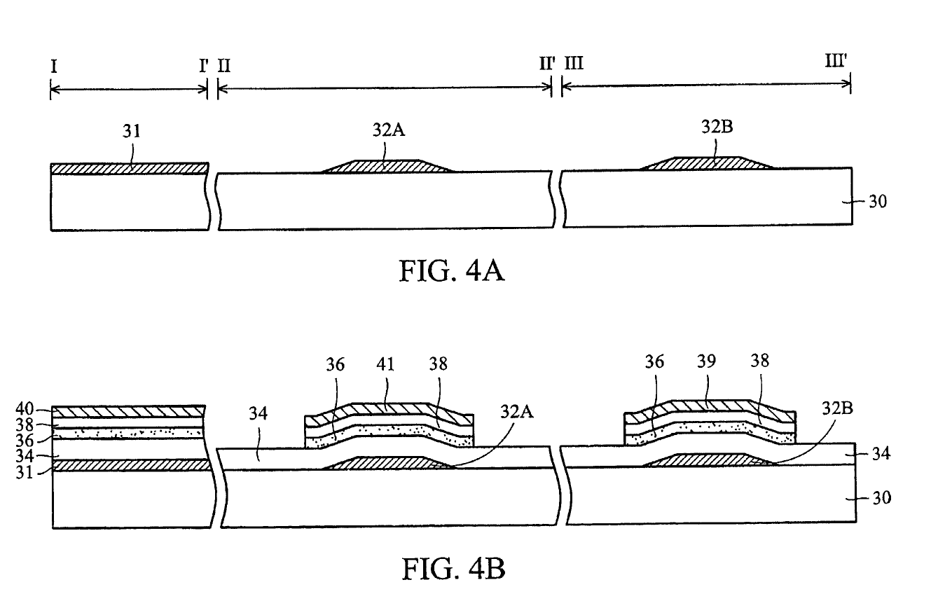

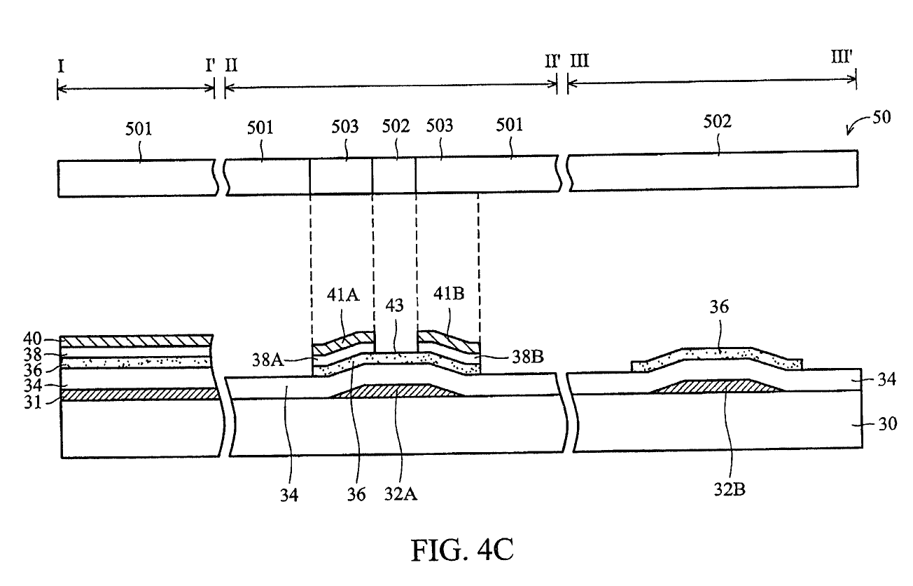

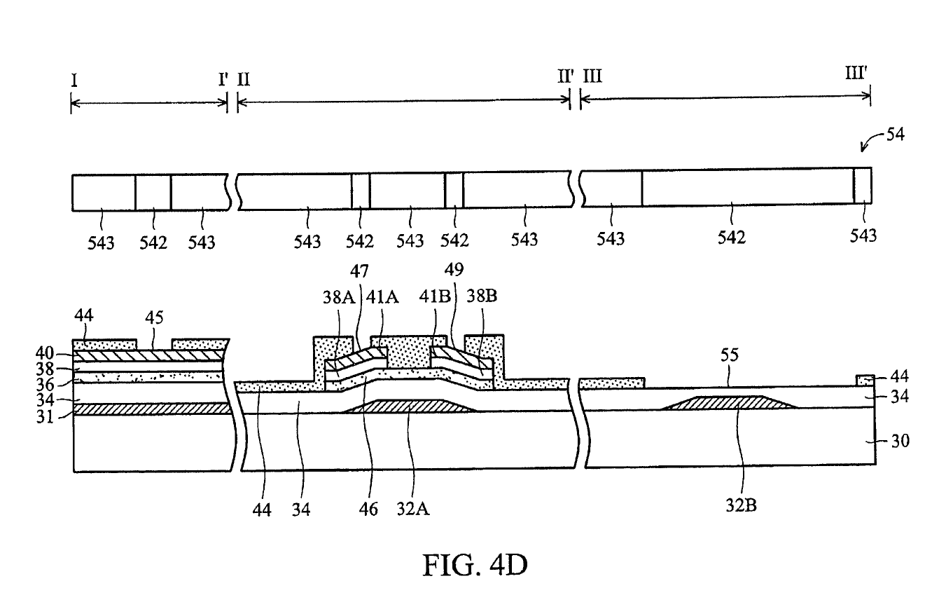

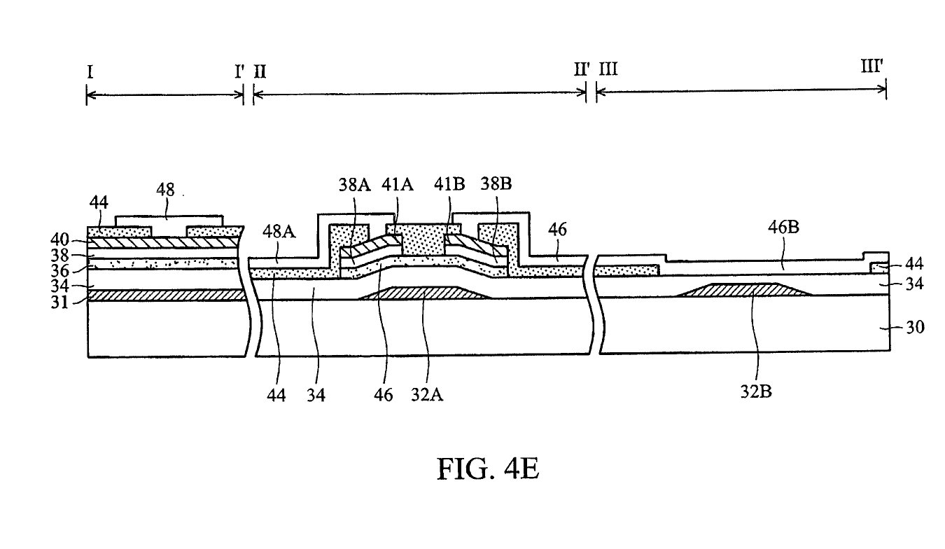

FIGS. 3A to 3D are top views showing the method of forming the TFT-LCD shown in FIG. 2. FIGS. 4A to 4E are sectional views along lines I-I′, II-II′, III-III′ shown in FIG. 3. As shown in FIGS. 3A and 4A, a first metal layer is deposited on a glass substrate 30, and then patterned by photolithography and etching with a first mask to form the gate line 32, the gate electrode 32A on the first region of the gate line 32, the storage capacitor 32B on the second region of the gate line 32, and a predetermined data line 31. Next, as shown in FIGS. 3B and 4B, an insulating layer 34 of silicon oxide/silicon nitride, a first semiconductor layer 36 of amorphous silicon, a second semiconductor layer 38 of n⁺-doped amorphous silicon, and a second metal layer 39 are successively deposited on the entire surface of the glass substrate 30. Then, using photolithography and etching with the gate line 32 and the predetermined data line 31 as the mask, part of the second metal layer 39, the second semiconductor layer 38 and the first semiconductor layer 36 are removed, thus the second metal layer 39 over the predetermined data line 31 is patterned to be the data line 40. Also, an island structure consisting of the second metal layer 39, the second semiconductor layer 38 and the first semiconductor layer 36 is formed over the gate electrode 32A, in which the second metal layer 39 over the gate electrode 32A serves as a source/drain metal layer 41.

As shown in FIGS. 3C and 4C, in the slit process, photolithography and etching with a first attenuated mask 50 and a positive-type photoresist are employed to form a first opening 43 on the island structure to expose the first semiconductor layer 36. Therefore, the source/drain metal layer 41 is separated to serve as the source electrode 41A and the drain electrode 41B, the second semiconductor layer 38 is separated to serve as a source region 38A and a drain region 38B, and the exposed region of the first semiconductor layer serves as a channel. In addition, the first semiconductor layer 36 over the storage capacitor 32B is exposed in the slit process.

The first attenuated mask 50 comprises a quartz plate and a cap layer that is defined as a first area 501, a second area 502 and a third area 503. The first area 501, made of transparent materials, has 100% transparency. The second area 502, preferably of MoSi, has 70-90% transparency to serve as a phase-shifting layer. The third area 503, preferably of chromium (Cr), has approximately 0% transparency to serve as an opaque layer. When the first attenuated mask 50 is utilized to perform the photolithography process on the positive-type photoresist, the areas 501, 502 and 503 having different transparencies make corresponding areas on the positive-type photoresist respectively receive different light intensity to achieve an incomplete exposure result. Thus, each etched depth of the corresponding areas on the positive-type photoresist is different, resulting in different etch depth of the corresponding areas on the depositing layers during the subsequent etching. Also, if the relationship between the areas 501, 502 and 503 is appropriately replaced, the first attenuated mask 50 can be applied in shaping a negative-type photoresist to the same profile.

As shown in FIGS. 3D and 4D, after depositing a protection layer 44 of silicon nitride on the entire surface of the glass substrate 30, another slit process with a second attenuated mask 54 and a positive-type photoresist is employed to form a second opening 45, a third opening 47 and a fourth opening 49. The second attenuated mask 54 comprises a first area 541 with 100% transparency, a second area 542 with 15-30% transparency and a third area 543 with 0% transparency. Accordingly, in the protection layer 44, the second opening 45 is formed over the intersection of the gate line 32 and the data line 40, the third opening 47 is formed over the source electrode 41A, and the fourth opening 49 is formed over the drain electrode 41B. Moreover, over the storage capacitor 32B, the protection layer 44 and the first semiconductor layer 36 can be removed to form a fifth opening 55. In addition, modulating the transparency of the corresponding areas 541, 542, 543 and corresponding parameters of the slit process, the thickness of the insulating layer 34 on the storage capacitor 32B can be reduced to increase the capacitance of the capacitor 52.

As shown in FIG. 4E, an ITO layer is deposited on the entire surface of the glass substrate 30 to fill the second opening 45, the third opening 47, the fourth opening 49 and the fifth opening 55. Then, using photolithography as etching with a third mask, the ITO layer is patterned to serve as the pixel electrode 46, the upper capacitor plate 46B, the metal shielding layer 48 and the extending portion 48A of the data line 40. In another case, etching the ITO layer may be replaced by lift-off process.

Compared with the conventional TFT-LCD process, the present invention uses three masks and two attenuated masks to pattern the TFT-LCD, and the present invention uses the final mask to pattern the pixel electrode 46, the upper capacitor plate 46B and the metal shielding layer 48 at the same step. Therefore, the present invention increases yield and decreases process costs of the TFT-LCD process. Also, since the ITO layer is used to form the upper capacitor plate 46B, the aperture ratio of the TFT-LCD is increased. Furthermore, the metal shielding layer 48 is provided to modulate the controlling voltage and solve the problem caused by the peripheral high-resistance circuits.

### Second Embodiment

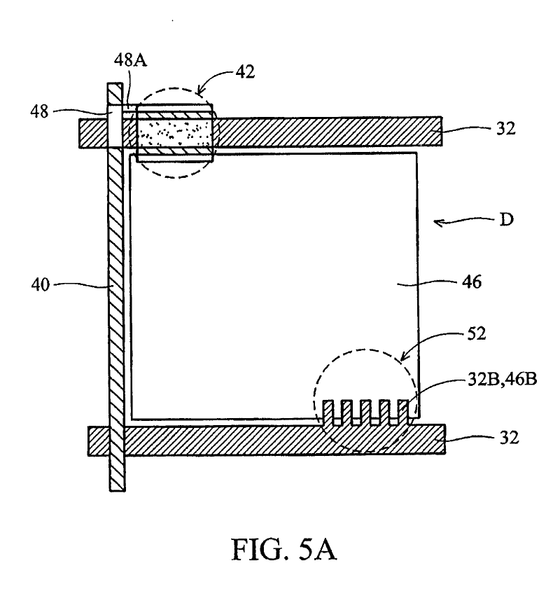

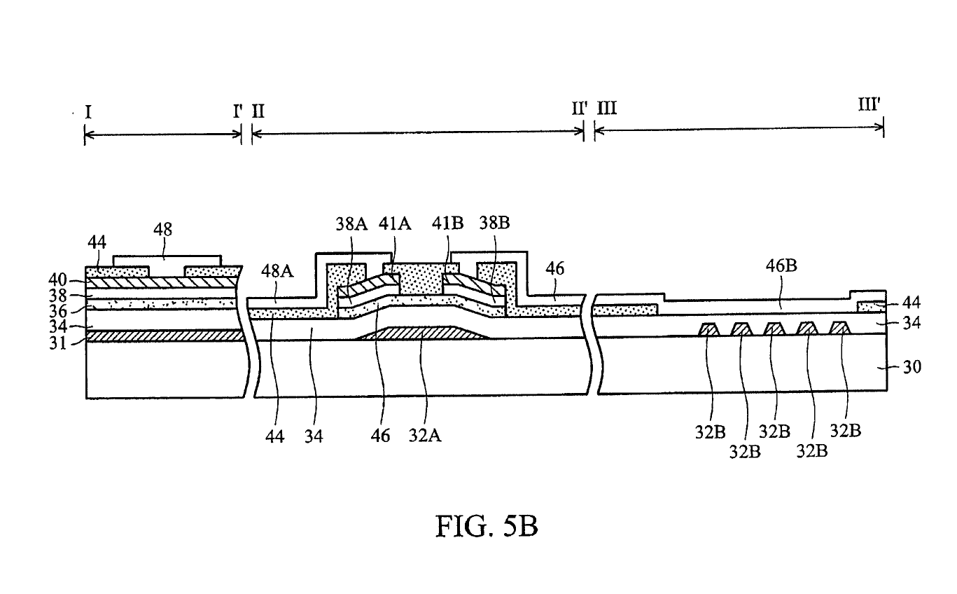

FIG. 5A is a top view showing a TFT-LCD according to the second embodiment of the present invention. FIG. 5B is a sectional view along lines I-I′, II-II′, III-III, shown in FIG. 5A. In order to improve the capacitance of the capacitor 52, the profile of the storage capacitor 32B is modified from a rectangular structure to a plurality of strips with tapered sidewalls, resulting in an increase in the total surface area of the storage capacitor 32B. The fabrication of the TFT-LCD of the second embodiment is the same as the steps described in the first embodiment.

It is to be understood that the present invention is not limited to the embodiments described above, but encompasses any and all embodiments within the scope of the following claims.

What is claimed is:

1. A TFT-LCD, comprising:
a plurality of parallel gate lines extending in a first direction;
a plurality of parallel data lines extending in a second direction, wherein each of the data lines is perpendicular to each of the gate lines; and
a plurality of arrayed pixel regions, wherein each of the pixel regions is a rectangular area formed by two adjacent gate lines and two adjacent data lines;
wherein each of the pixel regions comprises a pixel electrode covering the rectangular area, a TFT on a first region of the gate line, a capacitor on a second region of the gate line, and a metal shielding layer over the intersection of the gate line and the data line.

2. The TFT-LCD according to claim 1, wherein the metal shielding layer is connected to the data line.

3. The TFT-LCD according to claim 1, wherein the metal shielding layer has an extending portion that is connected to the drain electrode.

4. The TFT-LCD according to claim 2, wherein the metal shielding layer is indium tin oxide (ITO).

5. The TFT-LCD according to claim 1, wherein the capacitor comprises a storage capacitor formed on the second region of the gate line, and an upper capacitor plate formed using a part of the pixel electrode over the storage capacitor.

6. The TFT-LCD according to claim 5, wherein the upper capacitor plate is indium tin oxide (ITO).

7. The TFT-LCD according to claim 5, wherein the storage capacitor is a plurality of strips with tapered sidewalls that are in parallel and on a protruding portion of the second region of the gate line.

8. The TFT-LCD according to claim 1, wherein the pixel electrode is indium tin oxide (ITO).

9. A method of forming a TFT-LCD, comprising steps of:
providing a substrate;
depositing and patterning a first metal layer on the substrate to form a gate line and a predetermined data line, wherein a first region of the gate line serves as a gate electrode and a second region of the gate line serves as a storage capacitor;
successively forming an insulating layer, a first semiconductor layer, a second semiconductor layer and a second metal layer on the entire surface of the substrate;
using the predetermined data line as a mask to pattern the second metal layer as a data line, and forming an island structure having the second metal layer, the second semiconductor layer and the first semiconductor layer over the gate electrode;
forming a first opening on the island structure to separate the second metal layer as a source electrode and a drain electrode and separate the second metal layer as a source region and a drain region, and removing the second metal layer and the second semiconductor layer over the storage capacitor;
forming a protection layer having a second opening on the intersection of the data line and the gate line, a third opening on the source electrode, a fourth opening on the drain electrode, and a fifth opening over the capacitor storage, wherein the fifth opening passes through the protection layer and the first semiconductor layer over the capacitor storage; and
forming a transparent conductive layer to fill the second opening, the third opening, the fourth opening and the fifth opening, and patterning the transparent conductive layer as a metal shielding layer, a pixel electrode, and an upper capacitor plate, wherein the metal shielding layer fills the second opening and covers the intersection of the gate line and the data line and extends to fill the third opening, the pixel electrode fills the fourth opening and covers a rectangular region formed by the gate line and the data line, and the upper capacitor plate fills the fifth opening and covers the storage capacitor.

10. The method according to claim 9, wherein the storage capacitor is a bulk structure and protrudes from the second region of the gate line.

11. The method according to claim 9, wherein the storage capacitor is a plurality of strips with tapered sidewalls that are in parallel and on a protruding portion of the second region of the gate line.

12. The method according to claim 9, wherein the insulating layer is formed by a silicon oxide layer and silicon nitride layer.

13. The method according to claim 9, wherein the first semiconductor layer is amorphous silicon.

14. The method according to claim 9, wherein the second semiconductor layer is doped amorphous silicon.

15. The method according to claim 9, wherein the transparent conductive layer is indium tin oxide (ITO).

16. The method according to claim 9, wherein the first opening is formed using a first attenuated mask.

19. The method according to claim 9, wherein the second opening, the third opening, the fourth opening and the fifth opening are formed using a second attenuated mask.
